(19) United States
(12) Patent Application Publication
(10) Pub. No.: US 2026/0087854 A1
(43) Pub. Date: Mar. 26, 2026

(54) METHOD AND SYSTEM FOR INTEGRATED LIVENESS DETECTION AND IDENTITY VERIFICATION

(71) Applicant: ID R&D Inc., New York, NY (US)

(72) Inventors: Denis TIMOSHENKO, Jersey City, NJ (US); Alexey KHITROV, New York, NY (US); Konstantin SIMONCHIK, New York, NY (US)

(73) Assignee: ID R&D Inc., New York, NY (US)

(21) Appl. No.: 18/892,866

(22) Filed: Sep. 23, 2024

(51) Int. Cl. G06V 40/40; G06V 10/40; G06V 30/14; G06V 40/16; H04W 4/02

(52) U.S. Cl. CPC G06V 40/45; G06V 10/40; G06V 30/14; G06V 40/172; H04W 4/025

(57) ABSTRACT

A method and system for integrated liveness detection and identity verification initiates a verification process via an application in a device having a front camera and a rear camera, activates both front and rear cameras, records a video stream of an identification document from the rear camera simultaneously with a video stream of the face of the user from the front camera, synchronizes video frames from the both video streams, analyzes the video frames and detects liveness of the user and liveness of the identification document. The rear camera stream is analyzed to capture and to extract a face image from the identification document and to recognize the identification document. The front camera stream is analyzed to capture a live image of the face of the user. The live image of the face of the user is compared with the face image. Confirmation of the user's identity is made.

### FIELD OF THE INVENTION

The present invention generally relates to the field of digital identity verification, particularly to methods and systems for verifying liveness of a subject and authenticity of an identification document via a device having cameras.

### BACKGROUND OF THE INVENTION

Digital identity verification of the users is becoming increasingly difficult, especially in view of the fact that interactions between users and/or entities often occur over the Internet and less frequently face-to-face. Moreover, due to the increasing frequency of electronic interactions between users and/or entities, all types of interactions (e.g., Internet and/or face-to-face communication) are subject to potential security issues. Therefore, improved identity verification systems are needed to provide more accurate verification of users.

With the rising need for remote verification methods, existing solutions often require multiple steps that can be cumbersome for users and are susceptible to spoofing. A more secure method is needed to ensure the integrity of remote verification processes.

Meanwhile, many different known identity verification methods are described in the art, e.g. in US2021064901 A1 as published on 4 Mar. 2021, WO2020/021287A1 as published on 30 Jan. 2020, and US2020162457A1 as published on 21 May 2020.

The system disclosed in US2021064901A1 uses deep learning techniques for authenticating a user from an identification document, using automated verification of identification documents and detection that a live person identified by the document is present. Therefore, the known system uses sequential analysis of document images and human images.

WO2020/021287A1 discloses the system, wherein in response to a requirement for user liveness detection, the processor instructs the user to deploy the device in a facial image capture orientation in order to frame and capture a facial image (selfie) of the user. To confirm user liveness the CPU responds to the facial image capture to issues instructions that the device be moved from the facial image capture mode to a document capture mode. An identification document is framed in the touch screen by the user and an image of the document captured.

Liveness is confirmed by the processor poling the motion sensor output signal during movement of the device from the facial image capture mode to the document capture mode. If the device motion sensor output meets predetermined movement parameters user liveness is confirmed. If the motion sensor does not meet the parameters user liveness is denied.

Therefore, the system has two different sequential modes—a facial image capture mode and a document capture mode. Further, the liveness detection is provided using the motion sensor output signal during movement of the device from the facial image capture mode to the document capture mode.

US2020162457A1 discloses a system wherein the user captures an image of the user's verified identification document using an image captured device (e.g., camera, or the like) on the user's mobile device. For example, the user's verified identification may be the user's driver's license. The user also captures an image of the user's liveness identification that may be a video (or live image) of the user using a camera in the user's mobile device. Further, the captured image data associated with the images may be attached to the images captured, or otherwise stored and associated with the images for future transfer to the organization.

Therefore, all known systems use a sequential process for capturing an ID document image and a user's face image. Although, known systems take measures to protect against spoofing attacks, the sequential process cannot completely eliminate such attacks.

Therefore, development of improved reliable verification systems is an important concern in the art.

The present invention introduces a robust and user-friendly system designed for authenticating individuals remotely. It leverages devices having cameras to execute simultaneous document scanning and selfie capture. By employing a video stream from both the front and rear cameras, the system ensures strong liveness detection for both the individual's face and the identification document, enhancing security against fraudulent attempts.

### SUMMARY OF THE INVENTION

The proposed system comprises a device with an application that interfaces with the device's hardware, specifically front and back cameras of the device, as well as its gyroscope and accelerometer. The application is designed to guide a user through a simple verification process that captures and analyzes both the user's live face and their identification document in real-time.

The synchronization of the video streams is a critical aspect of the invention. By analyzing the synchronization of video jitter of specific points within the streams from the frontal and back cameras, the system can detect any discrepancies that would indicate potential frauds. Furthermore, the invention can correlate the video stream with the mobile device's gyroscope and accelerometer data to verify the liveness of the subject, adding an additional layer of security to the verification process.

It is an object of the present invention to improve liveness detection and identity verification of a user using a device having cameras.

In the first aspect of the present invention, provided is a method for integrated liveness detection and identity verification of a user using a device having at least one front camera and at least one rear camera, the method comprising: initiating a verification process via an application stored in the device; activating the at least one front camera from the at least one front camera and the at least one rear camera from the at least one rear camera of the device by the application; recording a video stream of an identification document from the activated at least one rear camera simultaneously with a video stream of a face of the user from the activated at least one front camera; synchronizing video frames from the both video streams; analyzing said synchronized video frames and detecting liveness of the user and liveness of the identification document, wherein the video stream from the activated at least one rear camera is analyzed to capture and to extract a face image from the identification document and to recognize the identification document, and the video stream from the activated at least one front camera is analyzed to capture a live image of the face of the user; comparing said live image of the face of the user with the face image extracted from the identification document; and confirming verification or not confirming verification of an identity of the user in a result of the comparing step and/or liveness detection.

According to an embodiment of the present invention, synchronization of said video frames from the video streams and analysis of said video frames provide a measure for liveness detection.

According to another embodiment of the present invention, a synchronous jitter of selected facial and document features is found in the synchronized video frames for analyzing to verify liveness.

According to another embodiment of the present invention, the method further includes synchronization with at least one motion sensor of the device, wherein such synchronization further verifies the liveness of the video streams.

According to another embodiment of the present invention, said at least one motion sensor provides an additional data stream that is used to check correlation with a synchronous jitter, ensuring the authenticity of an interaction with the user.

According to another embodiment of the present invention, said at least one motion sensor is at least one gyroscope and/or at least one accelerometer.

According to another embodiment of the present invention, the method further comprises performing an analysis to ensure that the video streams and the additional data stream from the at least one motion sensor are in sync for verification of a presence of the user and the identification document together in real-time.

According to another embodiment of the present invention, the method further comprises, when analyzing the video stream of the at least one rear camera, extracting personal data from the identification document using advanced optical character recognition (OCR) and pattern recognition algorithms.

According to another embodiment of the present invention, the steps of the method are used in remote onboarding and Know Your Customer (KYC) procedures.

According to another embodiment of the present invention, during recording of the video stream of the video stream from the at least one rear camera, the identification document is held by the user.

According to another embodiment of the present invention, the method further comprises, during recording of the video stream of the identification document from the at least one rear camera, recording a part of a body of the user in the video stream from the at least one rear camera together with the identification document.

In the second aspect of the present invention, a system for integrated liveness detection and identity verification of a user is provided, the system comprising: a device comprising at least one front camera, at least one rear camera, and a storage device which stores an application configured to initiate a verification process by the user and to activate at least one front camera of the at least one front camera and at least one rear camera of the at least one rear camera of the device, wherein the system is configured to provide recording of a video stream of an identification document from the activated at least one rear camera from the at least one rear camera simultaneously with a video stream of a face of the user from the activated at least one front camera from the at least one front camera, synchronization of video frames from both video streams, and analysis of said synchronized video frames and liveness detection of the user and the identification document, wherein the system is configured to analyze the video stream from the activated at least one rear camera to capture and to recognize the identification document and to analyze the video stream from the activated at least one front camera to capture a live image of the face of the user; the system is configured to compare said live image of the face of the user with an image extracted from the identification document; and the system is configured to confirm or not confirm an identity of the user in a result of the comparing and/or liveness detection.

According to an embodiment of the present invention, synchronization of said video frames from the video streams and analysis of said video frames provide a measure for liveness detection.

According to another embodiment of the present invention, the provided system is configured to find a synchronous jitter of selected facial and document features in the synchronized video frames for analyzing to verify liveness.

According to another embodiment of the present invention, the device further comprises at least one motion sensor, wherein the system is configured to provide synchronization with the at least one motion sensor, which further verifies the liveness of the video streams.

According to another embodiment of the present invention, said at least one motion sensor provides an additional data stream that is used by the system to check correlation with a synchronous jitter, ensuring authenticity of an interaction with the user.

According to other embodiment of the present invention, said at least one motion sensor is at least one gyroscope and/or at least one accelerometer.

According to other embodiment of the present invention, the provided system further configured to provide an analysis to ensure that the video streams and the additional data stream from the at least one motion sensor are in sync for verification of a presence of the user and the identification document together in real-time.

According to other embodiment of the present invention, the provided system further configured to use, during analysis of the video stream from the at least one rear camera, advanced optical character recognition (OCR) and pattern recognition algorithms for extracting personal data from the identification document.

According to other embodiment of the present invention, the provided system is designed for use in remote onboarding and Know Your Customer (KYC) procedures.

According to other embodiment of the present invention, the system is configured to provide recording of the video stream of the identification document from the at least one rear camera simultaneously with the video stream of the face of the user from the at least one front camera, when the identification document is held by the user.

According to other embodiment of the present invention, the system is configured to provide recording of the video stream of the identification document from the at least one rear camera simultaneously with the video stream of the face of the user from the at least one front camera, when a part of a body of the user is recorded in the video stream from the at least one rear camera together with the identification document.

The present invention according to any of the above-disclosed aspects provides reliable integrated liveness detection and identity verification.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the drawings, wherein:

FIG. 1 shows a general configuration of a system according to the present invention.

FIG. 2 shows the first part of a block diagram of a system for integrated liveness detection and identity verification according to the present invention.

FIG. 3 shows the second part of a block diagram of a system for integrated liveness detection and identity verification according to the present invention.

FIG. 4 shows the first part of a block diagram of a system for integrated liveness detection and identity verification according to the other embodiment of the present invention.

FIG. 5 shows a flow diagram of a method for integrated liveness detection and identity verification according to the present invention.

### DETAILED DESCRIPTION OF THE PREFERRED EMBODIMENTS

The present invention will now be described more fully with reference to the accompanying drawings, in which example embodiments of the present invention are illustrated. The subject matter of this disclosure may, however, be embodied in many different forms and should not be construed as being limited to the embodiments set forth herein.

A patent application for this invention disclose an innovative approach to digital identity verification, specifically tailored for remote onboarding and Know Your Customer (KYC) processes. The core of the invention is a zero-effort solution that seamlessly integrates three critical components: face liveness detection, face verification, and document recognition. The proposed solution allows the user to authenticate and gain access to the required resource without much effort and time. The user is prompted to capture a photo of an identification document using the device's rear camera while simultaneously taking a selfie with the front camera. This dual-capture approach not only makes the process more efficient for the user but also significantly improves security by allowing for the synchronization of video streams, which is a novel method of liveness detection.

The following example embodiments of the present invention are provided for performing a method for integrated liveness detection and identity verification using a device having rear and front cameras in the form of a dual-camera device. However, the present invention is not limited to using a mobile device; in particular, the present invention is also can use any device having rear and front cameras (e.g. such as smartphones, tablets, laptops, displays, smart displays, combination of such devices with separate camera devices, etc.) or a device configured to connect with rear and front cameras in another device. Further, the present invention discloses recording of a video stream of an identification document, for example, a passport, a driver's license, a military identification, other governmental identification, or other verified identification documents.

FIG. 1 shows a general configuration of a system according to the present invention. A user 1 holds a mobile device 3 having a front camera and a rear camera such that the rear camera of the device is able to record a video stream of an identification document 2 while the front camera of the device is able simultaneously to record a video stream of the face of the user 1. An appropriate application can be pre-installed on the mobile device and get started to initiate a verification process. In other embodiments, the appropriate application may not be pre-installed on the user's device, and initiating the verification process can be get started over the network using means known in the art. It is important to note that in other embodiments the device 3 can have two or more front cameras and two or more rear cameras, and at least one front camera from two or more front cameras and at least one rear camera from two or more rear cameras can be activated for recording correspondent video streams.

After both front and rear cameras of the device 3 are activated, recording a video stream of the identification document from the rear camera simultaneously with a video stream of the face of the user from the front camera is started. A part of a body of the user, for example a hand, can be recorded in the video stream from the rear camera together with the identification document. Further, video frames from the both video streams are synchronized. Then said synchronized video frames are analyzed. The rear camera stream is analyzed to capture and to extract a face image from the identification document and to recognize the identification document, and the front camera stream is analyzed to capture a live image of the face of the user. Then said live image of the face of the user with the face image extracted from the identification document are compared. Liveness of the user and liveness of the identification document are detected. In some embodiments, the identification document is held by the user during recording of the video stream of the identification document by rear camera, which can be used for providing additional information when detecting liveness of the user and liveness of the identification document. In the result of the comparing step and liveness detection, confirmation of verification or non-confirmation of verification of the user's identity are performed. It is important to note that, according to other embodiments, confirmation of verification or non-confirmation of verification of the user's identity can be performed in the result of the comparing step or in the result of the liveness detection.

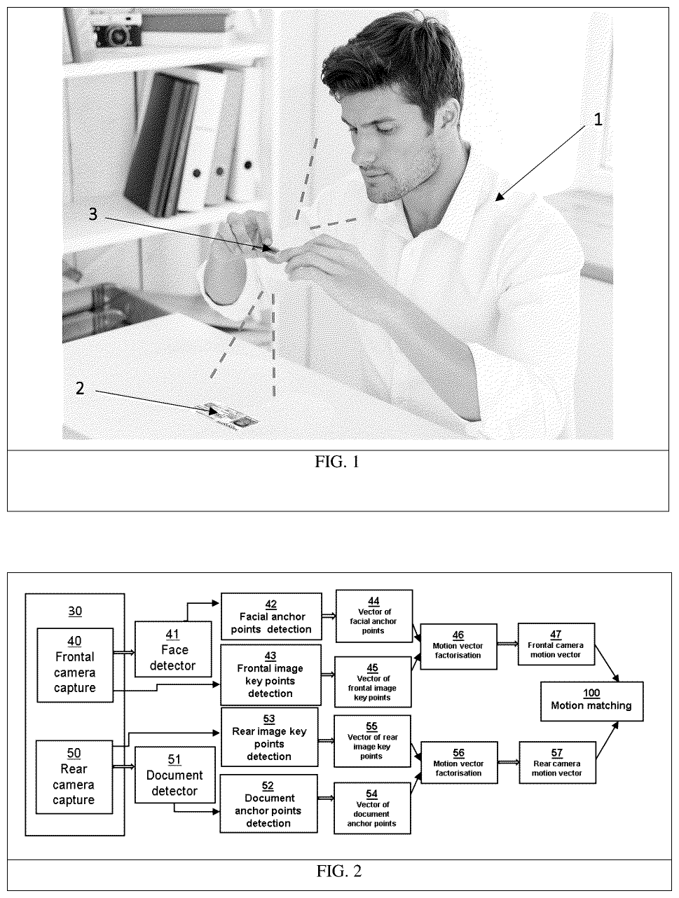

FIG. 2 shows the first part of a block diagram, wherein a system for integrated liveness detection and identity verification according to the present invention is presented.

The first part of a block diagram shows detection of video streams injections into the camera module using a software or a hardware based on comparing the movement of key points of two image streams.

API (application programming interface) 30 of the device activates a frontal camera capture 40 and a rear camera capture 50. The frontal camera capture 40 is associated with a face detector 41, which provides facial anchor points (landmarks) detection 42. The rear camera capture 50 is associated with a document detector 51, which provides document anchor points (landmarks) detection 52.

In real time, detection 43 of the frontal image key points coming from the front camera and accumulation of their coordinates are provided. Further, in real time, detection of facial image in the frames from the front camera is provided, the detection 42 of the facial anchor points and accumulation of their coordinates are provided. A vector 44 of facial anchor points is calculated based on the coordinates of the facial anchor points. A vector 45 of frontal image key points is calculated based on the coordinates of the frontal image key points. The trajectories of the facial points'movement are compared with the trajectories of movement of the points from the full image. The motion vector factorization 46 is provided based on the vectors 44, 45. A frontal camera motion vector 47 is extracted from the motion vector, where a facial movement (rotations, displacements) is excluded.

In real time, detection 53 of the rear image key points coming from the rear camera and accumulation of their coordinates are provided. Further, in real time, detection of a document image in the frames from the rear camera is provided, the detection 52 of the document anchor points and accumulation of their coordinates are provided. A vector 54 of document anchor points is calculated based on the coordinates of the document anchor points. A vector 55 of rear image key points is calculated based on the coordinates of the rear image key points. The trajectories of the document points'movement are compared with the trajectories of movement of the points from the full image. The motion vector factorization 56 is provided based on the vectors 54, 55. A rear camera motion vector 57 is extracted from the motion vector, where a document movement (rotations, displacements) is excluded.

The frontal camera motion vector 47 and the rear camera motion vector 57 are compared in the Motion matching module 100.

Synchronization algorithms ensure a precise combination of data from both cameras to achieve optimal results. The approach is based on comparing the jitter of base points extracted from video streams, and it is also possible to use an artificial convolutional neural network, which is trained to accept two video streams as input, returning a decision on stream synchronization. The feature “base points” refers to all points extracted from video frames: frontal image key points, rear image key points, document anchor points or facial anchor points.

Additionally, technology can be used to check the synchronization of the video stream(s) with data from the sensors of the mobile device (gyroscope, accelerometer, Hall sensor, etc.). The algorithm checks the synchronization of the base points'jitter of the video stream with the sensor data. It is possible to use an artificial neural network that is trained to receive a video stream and data from sensors as input, returning a decision on the synchronization of the streams and data from the sensors. An embodiment, in which data from the sensors are used in the proposed system, is shown further in FIG. 4.

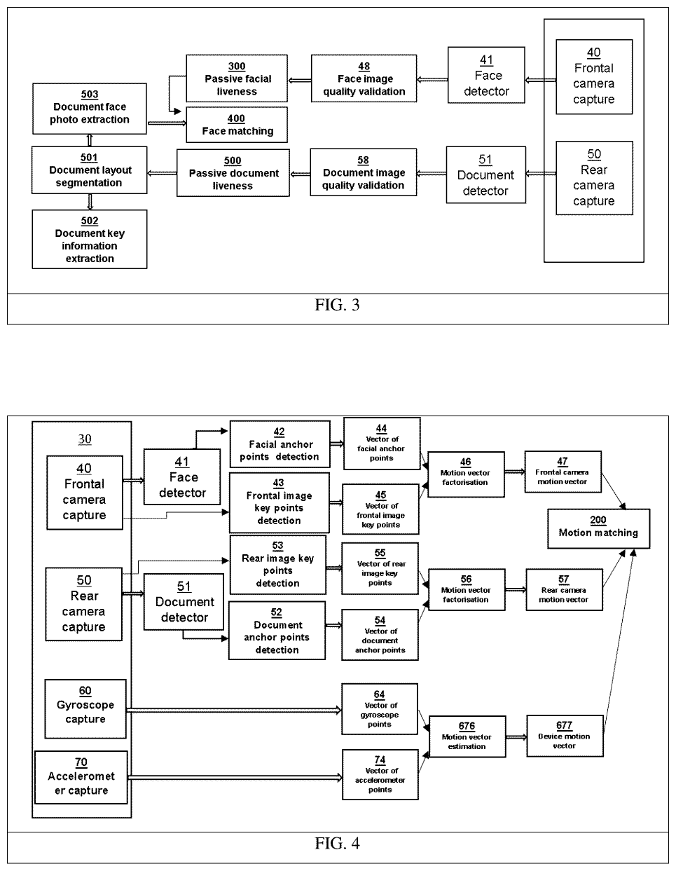

FIG. 3 shows the second part of a block diagram of a system for integrated liveness detection and identity verification according to the present invention. This second part is a corresponding part for the first part of the block diagram shown in FIG. 2 or FIG. 3. The second part of a block diagram shows the selection of frames of suitable quality from the front and rear cameras and the analysis of images of the face of the user and document, where this analysis includes checking liveness, verifying faces and recognizing key fields of documents.

API 30 of the device activates a frontal camera capture 40 and a rear camera capture 50. The frontal camera capture 40 is associated with the face detector 41. The rear camera capture 50 is associated with the document detector 51.

In real time, the faces are detected in frames received from the front camera, and the quality of the face image, for example, sharpness, size, position is simultaneously assessed. The frame that best satisfies the conditions of the face image quality validation 48 is selected. Liveness of the user is checked and passive facial liveness 300 of the user is performed.

In real time, the documents are detected in frames receiving from the rear camera and the document image quality, for example sharpness, size, position, is simultaneously assessed. The frame that best satisfies the conditions of the document image quality validation 58 is selected. The document is checked for liveness, that is passive document liveness 500 is performed.

The structure of the document is recognized, for example, the location of the fields, photos of the face, additional protective and informative areas. That is, the document layout segmentation 501 is performed. Key information of the document, for example, a full name, a date of birth, a document number, etc. is recognized using, for example, OCR (optical character recognition). That is, the document key information extraction 502 is performed. The position of the face image on the document is calculated and the document face photo extraction 503 is performed.

Face matching 400 that includes a biometric comparison of faces from the front camera and from the document is performed.

FIG. 4 shows the first part of a block diagram of a system for integrated liveness detection and identity verification according to another embodiment of the present invention. The first part of a block diagram shows detection of video streams injections into the camera module using a software or a hardware based on comparing the movement of key points of two image streams and data from device's position sensors.

This embodiment of the present invention comprises all features of the embodiment shown in FIG. 2 and further comprises a gyroscope capture 60 and/or an accelerometer capture 70.

In real time, accumulation of the coordinates receiving from the gyroscope and/or accelerometer sensors is provided. A vector 64 of gyroscope points and/or a vector 74 of accelerometer are calculated based on the accumulated coordinates receiving from the sensors. A motion vector estimation 676 is provided based on the vector 64 and/or vector 74. A device motion vector 677 is calculated based on the motion vector estimation 676.

Three motion vectors 47, 57, 677 are compared in the Motion matching module 200. The following combinations of comparing are possible depending on what modes are available. In a device simultaneous recording by two cameras may not be available.
Frontal camera motion vector 47 is compared with device motion vector 677.
Rear camera motion vector 57 is compared with device motion vector 677.
Frontal camera motion vector 47 is compared with rear camera motion vector 57.
Three vectors 47, 57, 677 together are compared.

The following information structure of the method according to the system for integrated liveness detection and identity verification according to the present invention is performed:
(1) Probability of liveness of the face image from the front camera (position 300 in FIG. 3).
(2) Probability of liveness of the document image from the rear camera (position 500 in FIG. 3).
(3) Probability of a match between the face image from the front camera and the face from the document (position 400 in FIG. 3).
(4) Key information extracted from the document (position 502 in FIG. 3).
(5) Likelihood of an attack by injecting video streams into the camera software module or into the camera hardware module (position 100 in FIG. 2 or position 200 in FIG. 4).

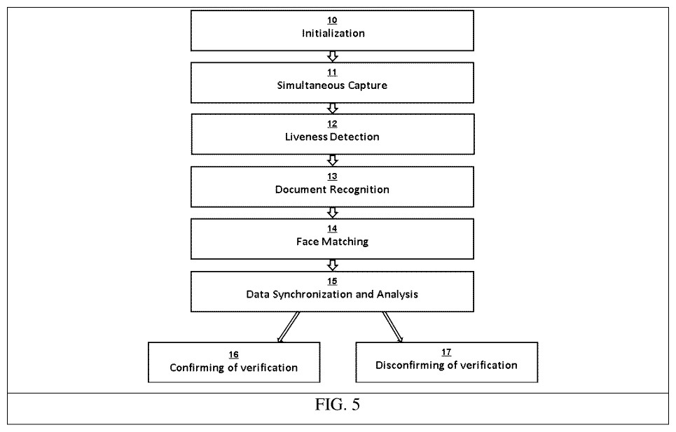

FIG. 5 shows a flow diagram of a method for integrated liveness detection and identity verification according to the present invention.
1. Initialization 10: The user initiates the verification process via the mobile application. The application activates both the front and rear cameras of the device and prepares to capture video streams.
2. Simultaneous Capture 11: The user is instructed to hold their identification document in view of the rear camera and simultaneously to look at the front camera. The system begins recording synchronized video streams from both cameras.
3. Liveness Detection 12: The system analyzes the synchronization of video frames from both streams. It looks for the synchronous jitter of selected facial and document features to verify liveness. Optionally, a gyroscope and/or an accelerometer provide additional data streams that the system uses to check the correlation with the jitter of the video streams, ensuring the authenticity of the interaction with the user.
4. Document Recognition 13: The rear camera stream is analyzed to capture and recognize the identification document. Advanced optical character recognition (OCR) and pattern recognition algorithms extract personal data from the document for verification.
5. Face Matching 14: The front camera stream captures a live image of the face of the user. The system compares this live image with the face image extracted from the identification document using facial recognition algorithms.
6. Data Synchronization and Analysis 15: A comprehensive analysis ensures that the video streams and the motion sensor data are in sync. This verifies the presence of the user and the document together in real-time.
7. Output:
   7.1 Confirming 16 of verification: Upon successful verification, the system confirms the user's identity.
   7.2 Not confirming 17 of verification: In the case of discrepancies or failed verification, the system provides feedback for additional steps or retries.

The advantages of the proposed method and system are improved protection against spoofing, acceleration and simplification of the identification process, and provision of a higher degree of belief in the verification process. The stability and reliability of the proposed system, which is a parallel system is much higher than that of a serial system known in the art, because a parallel data acquisition system checks the synchronization of data streams. The proposed system is protected against replay attacks.

It will be apparent to one of skill in the art that described herein are a novel method and a system for integrated liveness detection and identity verification. While the invention has been described with reference to specific preferred embodiments, it is not limited to these embodiments. The invention may be modified or varied in many ways and such modifications and variations, as would be obvious to one of skill in the art, are within the scope and spirit of the invention and are included within the scope of the following claims.

We claim:

1. A method for integrated liveness detection and identity verification of a user using a device having at least one front camera and at least one rear camera, the method comprising:
initiating a verification process via an application stored in the device;
activating both at least one front camera from the at least one front camera and at least one rear camera from the at least one rear camera of the device by the application;
recording a video stream of an identification document from the activated at least one rear camera simultaneously with a video stream of a face of the user from the activated at least one front camera;
synchronizing video frames from the both video streams;
analyzing said synchronized video frames and detecting liveness of the user and liveness of the identification document,
wherein the video stream from the activated at least one rear camera is analyzed to capture and to extract a face image from the identification document and to recognize the identification document, and the video stream from the activated at least one front camera is analyzed to capture a live image of the face of the user;
comparing said live image of the face of the user with the face image extracted from the identification document; and
confirming verification or not confirming verification of an identity of the user in a result of the comparing step and/or liveness detection.

2. The method of claim 1, wherein synchronization of said video frames from the video streams and analysis of said video frames provide a measure for liveness detection.

3. The method of claim 1, wherein a synchronous jitter of selected facial and document features is found in the synchronized video frames for analyzing to verify liveness.

4. The method of claim 1, wherein the method further includes synchronization with at least one motion sensor of the device, wherein such synchronization further verifies the liveness of the video streams.

5. The method of claim 4, wherein said at least one motion sensor provides an additional data stream that is used to check correlation with a synchronous jitter, ensuring the authenticity of an interaction with the user.

6. The method of claim 4, wherein said at least one motion sensor is at least one gyroscope and/or at least one accelerometer.

7. The method of claim 5, further comprising performing an analysis to ensure that the video streams and the additional data stream from the at least one motion sensor are in sync for verification of a presence of the user and the identification document together in real-time.

8. The method of claim 1, further comprising, when analyzing the video stream of the at least one rear camera, extracting personal data from the identification document using advanced optical character recognition (OCR) and pattern recognition algorithms.

9. The method of claim 1, wherein the steps of the method are used in remote onboarding and Know Your Customer (KYC) procedures.

10. The method of claim 1, wherein, during recording of the video stream of the video stream from the at least one rear camera, the identification document is held by the user.

11. The method of claim 1, further comprising, during recording of the video stream of the identification document from the at least one rear camera, recording a part of a body of the user in the video stream from the at least one rear camera together with the identification document.

12. A system for integrated liveness detection and identity verification of a user, the system comprising:
a device comprising at least one front camera, at least one rear camera, and a storage device which stores an application configured to initiate a verification process by the user and to activate at least one front camera of the at least one front camera and at least one rear camera of the at least one rear camera of the device, wherein
the system is configured to provide recording of a video stream of an identification document from the activated at least one rear camera from the at least one rear camera simultaneously with a video stream of a face of the user from the activated at least one front camera from the at least one front camera, synchronization of video frames from both video streams, and analysis of said synchronized video frames and liveness detection of the user and the identification document,
wherein the system is configured to analyze the video stream from the activated at least one rear camera to capture and to recognize the identification document and to analyze the video stream from the activated at least one front camera to capture a live image of the face of the user;
the system is configured to compare said live image of the face of the user with an image extracted from the identification document; and
the system is configured to confirm or not confirm an identity of the user in a result of the comparing and/or liveness detection.

13. The system of claim 12, wherein synchronization of said video frames from the video streams and analysis of said video frames provide a measure for liveness detection.

14. The system of claim 12, which is configured to find a synchronous jitter of selected facial and document features in the synchronized video frames for analyzing to verify liveness.

15. The system of claim 12, wherein the device further comprises at least one motion sensor, wherein the system is configured to provide synchronization with the at least one motion sensor, which further verifies the liveness of the video streams.

16. The system of claim 15, wherein said at least one motion sensor provides an additional data stream that is used by the system to check correlation with a synchronous jitter, ensuring authenticity of an interaction with the user.

17. The system of claim 15, wherein said at least one motion sensor is at least one gyroscope and/or at least one accelerometer.

18. The system of claim 16, further configured to provide an analysis to ensure that the video streams and the additional data stream from the at least one motion sensor are in sync for verification of a presence of the user and the identification document together in real-time.

19. The system of claim 12, further configured to use, during analysis of the video stream from the at least one rear camera, advanced optical character recognition (OCR) and pattern recognition algorithms for extracting personal data from the identification document.

20. The system of claim 12, which is designed for use in remote onboarding and Know Your Customer (KYC) procedures.

21. The system of claim 12, wherein the system is configured to provide recording of the video stream of the identification document from the at least one rear camera simultaneously with the video stream of the face of the user from the at least one front camera, when the identification document is held by the user.

22. The system of claim 12, wherein the system is configured to provide recording of the video stream of the identification document from the at least one rear camera simultaneously with the video stream of the face of the user from the at least one front camera, when a part of a body of the user is recorded in the video stream from the at least one rear camera together with the identification document.
